(19) United States
(12) Patent Application Publication
(10) Pub. No.: US 2010/0333172 A1
(43) Pub. Date: Dec. 30, 2010

(54) METHOD, APPARATUS AND SYSTEM FOR MONITORING DATABASE SECURITY

(76) Inventor: Wu Jiang, Chengdu (CN)

Correspondence Address: Huawei/BHGL, P.O. Box 10395, Chicago, IL, 60610, US

(21) Appl. No.: 12/873,918

(22) Filed: Sep. 1, 2010

Related U.S. Application Data
(63) Continuation of application No. PCT/CN2009/071723, filed on May 11, 2009.

(30) Foreign Application Priority Data
Apr. 25, 2008 (CN) 200810142578.5

(51) Int. Cl. G06F 21/00; G06F 15/173; G06F 17/30

(52) U.S. Cl. 726/1; 709/224; 707/781; 707/E17.005; 707/E17.032

(57) ABSTRACT

A system for monitoring database security includes a front-end probe that obtains network data information of a service system, a back-end probe that obtains database information accessed by the service system in a database system, and an analyzer that analyzes and integrates the obtained network data information and database information. The obtained network data information and database information are analyzed and integrated. The complete information about user operations at the front end of the service system and the front end of the database is obtained. User operations of the application system are associated with user operations of the database, and user operations can be audited completely.

### CROSS-REFERENCE TO RELATED APPLICATIONS

This application is a continuation of International Application No. PCT/CN2009/071723, filed on 11 May, 2009, which claims priority to Chinese Patent Application No. 200810142578.5, filed on Jul. 28, 2008, both of which are hereby incorporated by reference in their entireties.

### FIELD OF THE APPLICATION

The present application relates to information security technologies, and in particular, to a method, an apparatus, and a system for monitoring database security.

### BACKGROUND OF THE APPLICATION

With the popularity of computers and networks, the challenge of database security becomes more and more serious. More and more companies' core services are related to the Internet. Various network-based database application systems emerge one after another and provide information services for network users. The network system can be regarded as the external environment and basis of database applications. To play an important role, the database system requires the support from the network system, and users of the database system can access the database only through network. Therefore, database security first depends on the network system, and security of the network system is the first barrier to database security.

At present, database security methods mainly include the network probe technology, host agent technology, and log audit technology of the database system. The network probe technology of the database system probes packets in the network of the database system, obtains the packets, and then parses the packets according to the format of a database network protocol, thus performing security audit on the database access. The host agent technology of the database system records all operations in the database into a table by inserting a module in the database system and using the stored procedure and the trigger mechanism, thus auditing the database information as required. The log audit technology of the database system generates audit logs of database operations by using the auditing module of the database and then obtains the audit information to carry out analysis.

The method for monitoring database security in the prior art is mainly implemented through network data analysis, host agent, and log audit; data can be collected and analyzed in these modes, and all service system information is stored in the database. However, the method for associating service system access with database security and implementing end-to-end security audit from the terminal user or terminal software to the service system and then to the database system is unavailable in the prior art.

### SUMMARY OF THE APPLICATION

The embodiments below provide a method, an apparatus, and a system for monitoring database security, which can reflect end-to-end security audit and security protection, thus associating user operations of an application system with user operations of a database.

A method for monitoring database security includes:

obtaining network data information of a service system and database information accessed by the service system in a database system respectively; and

analyzing and integrating the obtained network data information and database information.

A system for monitoring database security includes:

a front-end probe, configured to obtain network data information of a service system;

a back-end probe, configured to obtain database information accessed by the service system in a database system; and

an analyzer, configured to analyze and integrate the obtained network data information and database information.

An analyzer for monitoring database security includes:

a front-end communicating module and a back-end communicating module, in communication with a front-end probe and a back-end probe respectively, configured to obtain data information or deliver an operation command; and

a data integrating module, configured to associate network data information obtained by the front-end communicating module with database information obtained by the back-end communicating module, thus recognizing the data operated in front-end service operations and back-end database operations.

The described technical solution provides at least the following benefits: The obtained network data information and database information are analyzed and integrated; the complete information about user operations at the front end of the service system and the front end of the database can be obtained; user operations of the application system are associated with user operations of the database; and user operations can be audited completely, and thus the problem that only the user operations of the database can be audited during database security audit is solved.

### BRIEF DESCRIPTION OF THE DRAWINGS

To illustrate the technical solution according to the embodiments more clearly, the accompanying exemplary drawings are provided.

FIG. 1 is a schematic drawing of a system for monitoring database security in an embodiment;

FIG. 2 is a structure of a probe in a system for monitoring database security in an embodiment;

FIG. 3 is a structure of an analyzer in a system for monitoring database security in an embodiment;

FIG. 4 is a flowchart of a method for monitoring database security in an embodiment;

FIG. 5 is a flowchart of a method for monitoring database security in the modeling phase in an embodiment;

FIG. 6 is a flowchart of a method for monitoring database security in the working phase in an embodiment; and

FIG. 7 is a structure of a template of a method for monitoring database security in an embodiment.

### DETAILED DESCRIPTION

The following detailed description of various exemplary embodiments is provided with reference to the accompanying drawings.

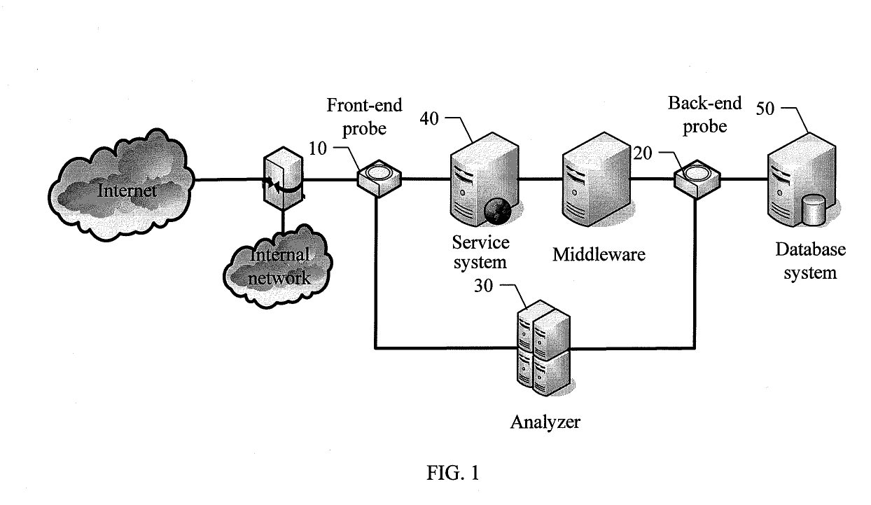

As shown in FIG. 1, the system for monitoring database security in an embodiment includes a front-end probe 10, a back-end probe 20, and an analyzer 30. The front-end probe 10 is placed at the front end of the protected service system 40, and is configured to obtain network data information of the service system. The back-end probe 20 is placed in the network between the service system 40 and the database system 50, and is configured to obtain the database information accessed by the service system 40 in the database system 50. The analyzer 30 is connected to the front-end probe 10 and the back-end probe 20, and is configured to analyze and integrate the obtained network data information and database information. In this way, end-to-end audit of the user operations in the database is implemented. It is understandable that if multiple application servers or database servers exist, multiple front-end probes 10 and multiple back-end probes 20 may be set.

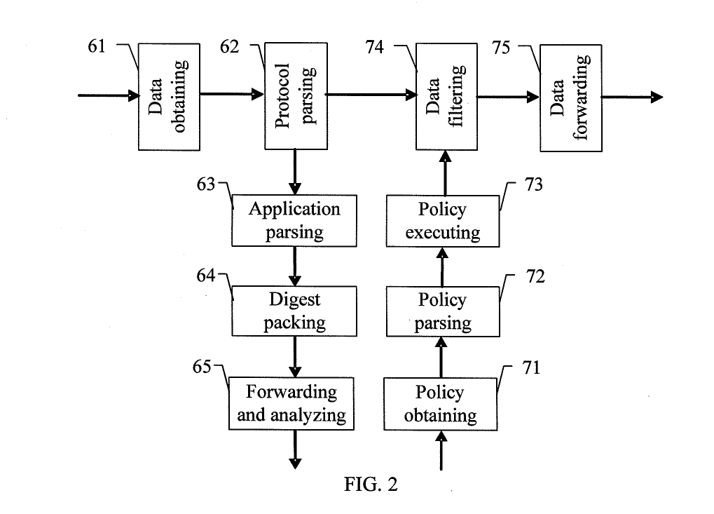

As shown in FIG. 2, in the system for monitoring database security in an embodiment, the structure and working principle of the front-end probe 10 are basically the same as those of the back-end probe 20. The data obtaining module 61 obtains required network data information or database information from the service system 40 and the database system 50; the protocol parsing module 62 parses the service protocol and database access protocol; the parsed protocol information is transmitted to the analyzer 30 according to a specified format through the application parsing module 63, the digest packing module 64, and the forwarding and analyzing module 65 in turn. It is understandable that the process is cyclic. At the same time, the front-end probe 10 and the back-end probe 20 accept the filtering policy delivered by the analyzer 30 through the policy obtaining module 71, and the policy parsing module 72 parses the policy. The parsed policy is then transmitted through the policy executing module 73, the data filtering module 74, and the data forwarding module 75 in turn to the service system 40 and the database system 50 for execution.

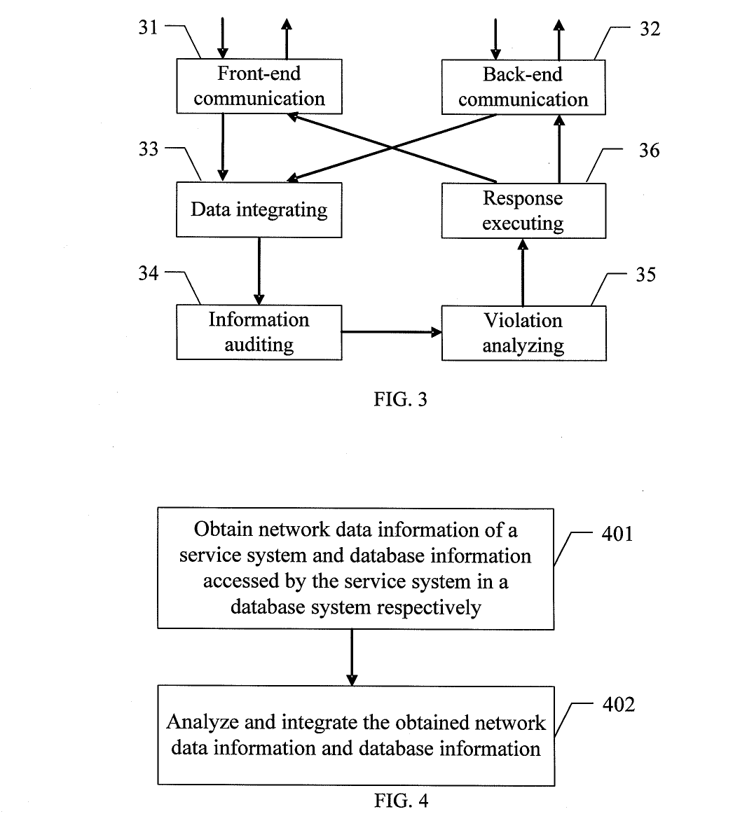

As shown in FIG. 3, the analyzer 30 in the system for monitoring database security in an embodiment includes:

a front-end communicating module 31 and a back-end communicating module 32, in communication with a front-end probe 10 and a back-end probe 20 respectively, configured to obtain data information or deliver an operation command;

a data integrating module 33, connected to the front-end communicating module 31 and the back-end communicating module 32, and configured to associate the network data information obtained by the front-end communicating module 31 with the database information obtained by the back-end communicating module 32, thus recognizing the data operated in front-end service operations and back-end database operations;

an information auditing module 34, connected to the data integrating module 33 and a violation analyzing module 35, and configured to record the data recognized by the data integrating module 33 in the audit format and then transmit the data to the violation analyzing module 35;

the violation analyzing module 35, configured to: receive the data transmitted by the information auditing module 34 and determine, according to a preset rule, whether violation occurs, and, if violation occurs, generate a new filtering policy and notify a response executing module 36; and

the response executing module 36, configured to receive the generated filtering policy and transmit the filtering policy to the front-end probe 10 and the back-end probe 20 respectively through the front-end communicating module 31 and the back-end communicating module 32, thus blocking subsequent operations. Generally, the preceding filtering policy command is similar to a traditional access control list (ACL), which mainly controls the access of application protocols and whether to perform operations such as blocking the corresponding communication.

As shown in FIG. 4, a method for monitoring database security in an embodiment includes:

401: Obtain network data information of a service system and database information accessed by the service system in a database system respectively.

402: Analyze and integrate the obtained network data information and database information.

It is understandable that the data integrating operation in the method for monitoring database security can establish a one-to-one or one-to-many mapping between the network data information obtained by the front-end probe 10 and the database information obtained by the back-end probe 20. With the mapping, the complete information about user operations at the front end of the service system and the front end of the database can be obtained; and user operations can be audited completely, and thus the problem that only the user operations of the database can be audited during database security audit is solved. After the analysis and integration are completed, the integrated and recognized data is audited and recorded, and whether violation occurs is determined according to a preset rule; if violation occurs, a new filtering policy is generated.

It is understandable that the method for monitoring database security in an embodiment can parse database access protocols such as Transparent Network Substrate (TNS), Distributed Relational Database Architecture (DRDA), and Tabular Data Stream (TDS) to parse network data of mainstream databases such as Oracle\DB2\MS SQL, obtain the database operations and database user operations through parsing, and obtain the IP address, account, and request operation of the service user by parsing service system data. Such a service request often forms one or more database operations. With the mapping between the database operations and the service operations, an audit link of user operations is formed from the service system to the database to determine whether an operation violates the requirement and to reject the request out of the link. To further ensure the normal execution of audit, the method for monitoring database security may be arranged to learn for a period of time before normal usage so as to establish a mapping between the service access and the database operation. Secondly, because the method for monitoring database security connects the front-end probe 10 and the back-end probe 20 in series with the network, the application access request that does not comply with the access protocol format is discarded and cannot arrive at the actual system, and thus resource consumption is avoided. Thirdly, the method for monitoring database security creates an access matrix between the database and the service user through the analyzer 30; if an access request does not comply with the access matrix, the access request is rejected by the back-end probe 20.

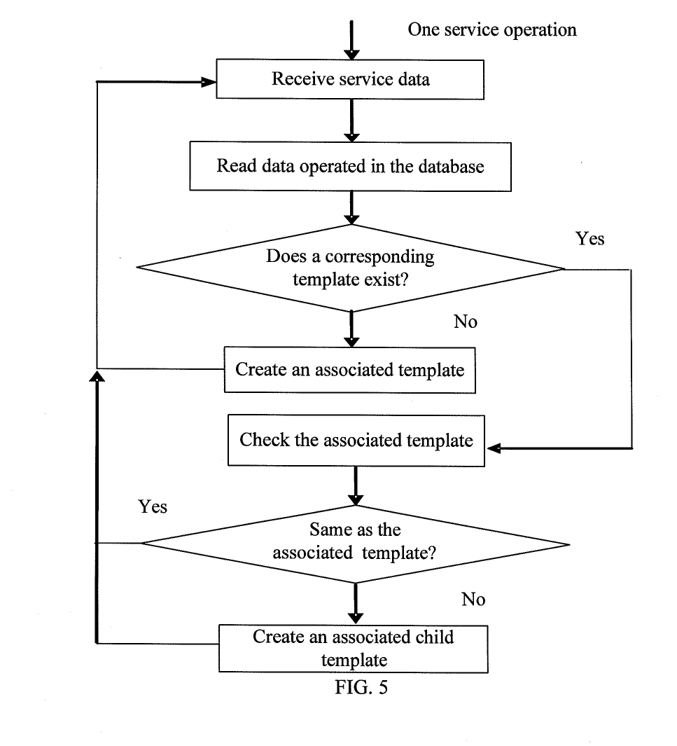

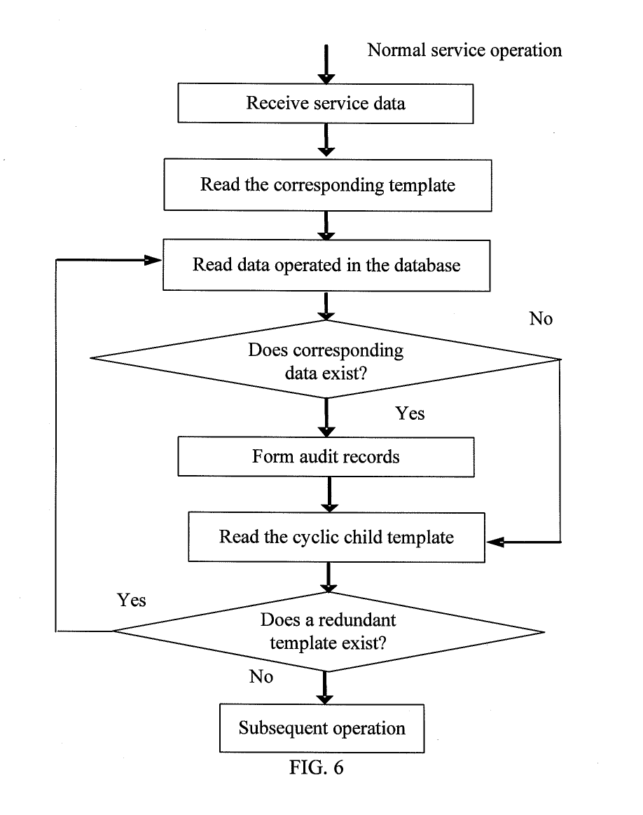

As shown in FIG. 5 and FIG. 6, to further ensure the normal execution of audit, the system for monitoring database security in an embodiment may be arranged to learn for a period of time before normal usage. In other words, data integration is divided into modeling phase and working phase. In the modeling state, an associated template for access is created by establishing the mapping between service application access and database access. In this way, in the working state, as long as the access matches the template, data can be extracted, and access analysis is not required any longer, which further improves efficiency.

The following describes the implementation processes of the two phases.

Modeling phase: When performing one service operation, receive service data, read the data operated in the database, and determine whether an associated template exists; if no such template exists, create an associated template and then return to the step of receiving service data; if such a template exists, check the associated template and determine whether the template is the same as the associated template; if the template is the same as the associated template, return to the step of receiving service data; otherwise, create an associated template and then return to the step of receiving service data.

Working phase: When a normal service operation is performed after completion of the modeling phase, receive service data, read the corresponding template and the data operated in the database, determine, according to whether corresponding data exists, whether to form audit records; then read the cyclic child template, determine whether a redundant template exists; if a redundant template exists, return to the step of reading the data operated in the database; if no redundant template exists, continue the subsequent operation.

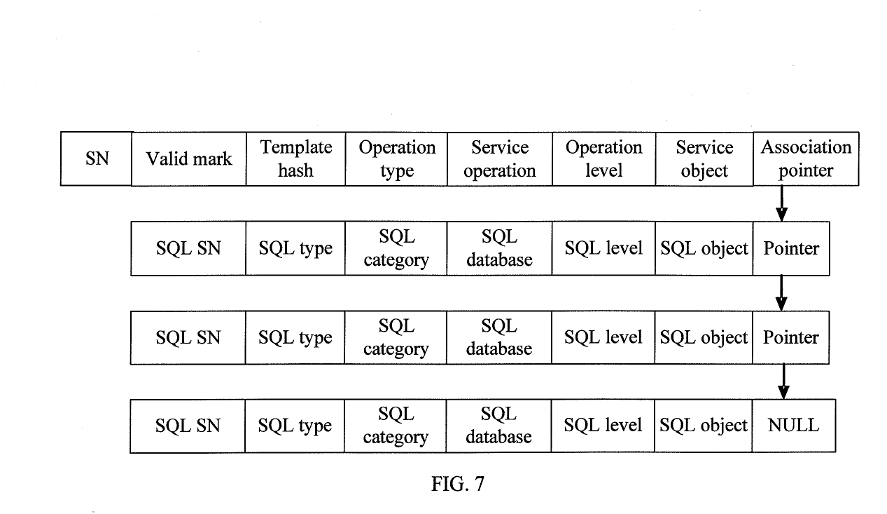

As shown in FIG. 7, taking the format of a template as an example, the first record indicates service data information. An association pointer can associate the service operation of the record with the corresponding database operation. The last three records are the corresponding database operation pointers. A template hash indicates the hash results obtained by the hash function according to the service operation type, service operation, operation level, and service object. Usually the template hash method is used to compare a template with an old template to see whether they are the same. If the template hash is the same but the subsequent database operation commands are different, the new template is a child template of the old template, and the corresponding template sequence number (SN) is different. In addition, the database operation statements are in sequence. The audit record is to record actual data according to the template. Therefore, the audit record has more data than the template. In the service data part of the excess data, fields such as the service user name, IP address of the service user terminal, and access time of the service user may be added. In each database operation, some fields, such as the user name of the database operation, database operation time, database operation details, and whether an operation succeeds, may be added, and the structure is similar to the preceding structure.

It is understandable that the common Web applications in actual applications are combined with the applications of the MS SQL Server database to describe the method, apparatus, and system for monitoring database security in embodiments. In certain embodiments, the front-end probe 10 obtains network HTTP data for parsing protocols; the back-end probe 20 parses the TDS protocol of the SQL database. The two probes send data to the data integrating module 33 of the analyzer 30 as soon as possible; the data integrating module 33 performs matching according to the template that is formed through learning completed in advance, first fills the service operation type, service operation, operation level, and service object according to the HTTP statement, and then forms a hash according to the filled contents. Afterwards, the data integrating module 33 reads the bucket array of the template table, reads the same hash according to the valid marks, and if a same hash is found, queries the TDS data for the recent data complying with the event according to the SQL event SN recorded in the template, and completes the filling of the entire audit event structure.

Persons of ordinary skill in the art should understand that all or part of the steps of the method according to the embodiments may be implemented by a program instructing relevant hardware. The program may be stored in a computer readable storage medium. When the program runs, the steps of the method according to the embodiments of the present invention are performed. The storage medium may be a magnetic disk, a compact disk read-only memory (CD-ROM), a read-only memory (ROM) or a random access memory (RAM).

Detailed above are only some exemplary embodiments. It is apparent that those skilled in the art can make various modifications and variations to these embodiments without departing from the spirit and scope of the claims.

What is claimed is:

1. A method for monitoring database security, comprising:
obtaining network data information of a service system and database information accessed by the service system from a database system respectively;
establishing a one-to-one or one-to-many mapping between the obtained network data information and the obtained database information; and
analyzing and integrating the obtained network data information and database information according to the one-to-one or one-to-many mapping.

2. The method of claim 1, wherein the obtained network data information of the service system comprises at least one of the following items: an IP address of a service user, an account of the service user, and a request operation of the service user.

3. The method of claim 1, wherein the obtained database information accessed by the service system in the database system comprises at least one of: a database operation and a database user.

4. The method of claim 1, wherein the integrating operation further comprises: in the modeling phase, establishing a mapping between the network data information of the service system and the database information accessed by the service system in the database system, and creating an associated template for access.

5. The method of claim 1, wherein after the analyzing and integrating operation, the method further comprises:
auditing and recording the integrated obtained network data information and database information;
determining, according to a preset rule, whether a violation occurs; and
generating a new filtering policy if the violation occurs.

6. A system for monitoring database security, comprising:
a front-end probe, configured to obtain network data information of a service system;
a back-end probe, configured to obtain database information accessed by the service system in a database system; and
an analyzer, configured to analyze and integrate the obtained network data information and database information.

7. The system of claim 6, wherein: the front-end probe is placed at a front end of a protected service system, and the back-end probe is placed in a network between the service system and the database system.

8. The system of claim 6, wherein: the front-end probe is configured to obtain required network data information from the service system, and the back-end probe is configured to obtain required database information from the database system through a data obtaining module, respectively, parse a service protocol and a database access protocol through a protocol parsing module, respectively, and then transmit the parsed protocol information to the analyzer through an application parsing module, a digest packing module, and a forwarding and analyzing module in turn according to a specified format.

9. The system of claim 6, wherein: the front-end probe and the back-end probe are configured to accept a filtering policy delivered by the analyzer through a policy obtaining module, and after a policy parsing module parses the policy, transmit the policy to the service system and the database system through a policy executing module, a data filtering module, and a data forwarding module in turn.

10. The system of claim 6, wherein the analyzer comprises:
a front-end communicating module, in communication with the front-end probe, configured to obtain data information or deliver an operation command;
a back-end communicating module, in communication with the back-end probe, configured to obtain data information or deliver an operation command; and
a data integrating module, configured to associate network data information obtained by the front-end communicating module with database information obtained by the back-end communicating module, thus recognizing the data operated in front-end service operations and back-end database operations.

11. The system of claim 10, wherein the analyzer further comprises:
an information auditing module, configured to audit and record the recognized data by the data integrating module; and
a violation analyzing module, configured to: receive the data that is audited and recorded and then transmitted by the information auditing module, determine, according to a preset rule, whether violation occurs, and, if violation occurs, generate a new filtering policy.

12. The system of claim 11, wherein the analyzer further comprises:
a response executing module, configured to receive the generated filtering policy, and transmit the policy to the front-end probe and the back-end probe through the front-end communicating module and the back-end communicating module, respectively.

13. An analyzer for monitoring database security, comprising:
a front-end communication module, in communication with a front-end probe, configured to obtain data information or deliver an operation command;
a back-end communication module, in communication with a back-end probe respectively, configured to obtain data information or deliver an operation command; and
a data integrating module, configured to associate network data information obtained by the front-end communication module and database information obtained by the back-end communication module, so as to recognize data obtained by the front-end service communication module and the back-end communication module.

14. The analyzer of claim 13, further comprising:
an information auditing module, configured to audit and record the data recognized by the data integrating module; and
a violation analyzing module, configured to: receive the data that is audited and recorded and then transmitted by the information auditing module; and determine, according to a preset rule, whether a violation occurs, and, if the violation occurs, generate a new filtering policy.

15. The analyzer of claim 14, further comprising:
a response executing module, configured to receive the generated filtering policy, and transmit the policy to the front-end probe and the back-end probe through the front-end communication module and the back-end communication module respectively.
